(19) United States
(12) Patent Application Publication
(10) Pub. No.: US 2011/0157215 A1
(43) Pub. Date: Jun. 30, 2011

(54) IMAGE OUTPUT DEVICE, IMAGE OUTPUT SYSTEM AND IMAGE OUTPUT METHOD

(75) Inventor: Yuko Aoyagi, Tokyo (JP)

(73) Assignee: FUJIFILM Corporation, Tokyo (JP)

(21) Appl. No.: 12/975,193

(22) Filed: Dec. 21, 2010

(30) Foreign Application Priority Data
Dec. 28, 2009 (JP) JP2009-297875

(51) Int. Cl. G09G 5/02; G09G 5/00

(52) U.S. Cl. 345/593; 345/619

(57) ABSTRACT

An image output method, which can be executed an information processing device, includes the steps of: storing in a storage medium layout definition information defining a layout of output information suitable to a display capability for each mobile information terminal to which identification information is assigned; receiving designation of desired output information through the mobile information terminal; receiving the identification information of the mobile information terminal from the mobile information terminal; selecting from the storage medium layout definition information corresponding to the received identification information of the mobile information terminal; and creating an image in which the output information, the designation of which has been received, is arranged according to a layout defined by the selected layout definition information.

### BACKGROUND OF THE INVENTION

1. Field of the Invention

The presently disclosed subject matter relates to selection of print contents using a mobile information terminal and to a preview display of the print contents according to the selection.

2. Description of the Related Art

According to Japanese Patent Application Laid-Open No. 2005-269268 (paragraphs 0057 and 0059, and FIG. 7), when a communication unit 204 of a content server 2 receives image data of interest from a cellular phone 7 (C1), a control unit 206allows the communication unit 204 to transmit selection menu information (representing a selection menu for allowing a user to select particular decorating image data from a plurality of pieces of decorating image data stored in a decorating image data storage unit 201) (C2). When the communication unit 204 of the content server 2 receives instructions to designate the decorating image data from the cellular phone 7 (C3), a data searching unit 205 searches from the decorating image data storage unit 201 the decorating image data designated by the instructions to designate the decorating image data and reads the searched decorating image data (C4). An image synthesis unit 202 then synthesizes the image data received in C1 with the read decorating image data (C5).

The communication unit 204 transmits the resultant synthesized image data to a document server 3 (C6).

Other techniques related to the presently disclosed subject matter are described in the following documents: Japanese Patent Application Laid-Open No. 2006-115044, Japanese Patent Application Laid-Open No. 2009-78373, and Japanese Patent Application Laid-Open No. 2005-128852.

### SUMMARY OF THE INVENTION

In the conventional art, when information such as an image and a document stored in a mobile information terminal is directly output to an external device such as a printer, if a batch output of designated information is performed, disadvantageously an unwanted part is also output.

An object of the presently disclosed subject matter is to selectively output an image of a required part of information using a mobile information terminal.

A first aspect of the presently disclosed subject matter provides an image output device including: a communication unit capable of communicating information with a mobile information terminal connected with the communication unit; a layout definition information storage unit configured to store layout definition information defining a layout of output information suitable to a display capability for each mobile information terminal to which identification information is assigned; an output information designation unit configured to receive designation of desired output information through the mobile information terminal connected with the communication unit; a reception unit configured to receive the identification information of the mobile information terminal from the mobile information terminal connected with the communication unit; a selection unit configured to select, from the layout definition information storage unit, layout definition information corresponding to the identification information of the mobile information terminal received by the reception unit; and an image processing unit configured to create an image in which the output information of which the output information designation unit has received the designation is arranged according to a layout defined by the layout definition information selected by the selection unit.

A second aspect of the presently disclosed subject matter provides an image output device according to the first aspect, wherein the display capability of the mobile information terminal includes at least one of screen resolution and display colors of the mobile information terminal; and the image processing unit creates an image in which the output information is arranged to be suitable to the at least one of the screen resolution and the display colors of the mobile information terminal.

A third aspect of the presently disclosed subject matter provides an image output device according to the second aspect, wherein the selection unit calculates output sizes of each piece of the output information of which the output information designation unit has received the designation, based on the screen resolution of the mobile information terminal connected with the communication unit, and selects the layout definition information according to identity of the calculated output sizes of each piece of the output information.

A fourth aspect of the presently disclosed subject matter provides an image output device according to the third aspect, wherein if the calculated output sizes of each piece of the output information are not identical to each other, the selection unit selects, from the layout definition information storage unit, layout definition information corresponding to a majority of the output sizes in the calculated output sizes of each piece of the output information.

A fifth aspect of the presently disclosed subject matter provides an image output device according to the fourth aspect, wherein the selection unit selects, from the layout definition information storage unit, layout definition information suitable to screen resolution most approximate to the majority of the output sizes.

A sixth aspect of the presently disclosed subject matter provides an image output device according to any one of the first to fifth aspects, further including: a printer output definition information storage unit configured to store printer output definition information defining an output specification for each printer; a printer designation unit configured to receive designation of a desired printer through the mobile information terminal; a print data processing unit configured to create print data suitable to the output specification defined by printer output definition information corresponding to the printer of which the printer designation unit has received the designation, in the printer output definition information storage unit, based on the output information arranged according to the layout defined by the layout definition information selected by the selection unit; and a transmitting unit configured to transmit the print data from the print data processing unit to the printer of which the printer designation unit has received the designation.

A seventh aspect of the presently disclosed subject matter provides an image output device according to any one of the first to sixth aspects, further including an image transmitting unit configured to transmit an image from the image processing unit to the mobile information terminal connected with the communication unit.

A eighth aspect of the presently disclosed subject matter provides an image output system including: an image output device according to any one of the first to seventh aspects; and a mobile information terminal.

A ninth aspect of the presently disclosed subject matter provides an image output method, wherein an information processing device executes the steps of: storing in a storage medium layout definition information defining a layout of output information suitable to a display capability for each mobile information terminal to which identification information is assigned; receiving designation of desired output information through the mobile information terminal; receiving the identification information of the mobile information terminal from the mobile information terminal; selecting from the storage medium layout definition information corresponding to the received identification information of the mobile information terminal; and creating an image in which the output information, the designation of which has been received, is arranged according to a layout defined by the selected layout definition information.

A tenth aspect of the presently disclosed subject matter provides a computer-readable recording medium including instructions stored thereon, such that when the instructions are read and executed by a processor, the processor is configured to perform the steps of: storing in a storage medium layout definition information defining a layout of output information suitable to a display capability for each mobile information terminal to which identification information is assigned; receiving designation of desired output information through the mobile information terminal; receiving the identification information of the mobile information terminal from the mobile information terminal; selecting from the storage medium layout definition information corresponding to the received identification information of the mobile information terminal; and creating an image in which the output information, the designation of which has been received, is arranged according to a layout defined by the selected layout definition information.

According to the presently disclosed subject matter, an image in which desired information selected in a mobile information terminal is arranged in a layout suitable to display capability of the mobile information terminal is created. The image is displayed on a display device of the mobile information terminal or output to different types of printers, thereby allowing outputting the required information through the mobile information terminal.

### BRIEF DESCRIPTION OF THE DRAWINGS

FIG. 1 is a diagram for illustrating a configuration of a print system;

FIG. 2 illustrates an example of a template;

FIGS. 3A and 3B illustrate examples of templates for an electronic mail;

FIG. 4 illustrates an example of a template for a web site;

FIG. 5 illustrates another example of a template for a web site;

FIG. 6 is a block diagram for illustrating a mobile information terminal;

FIG. 7 is a block diagram for illustrating a server;

FIG. 8 is a diagram for illustrating a concept of information in a terminal information DB;

FIG. 9 is a diagram for illustrating a concept of information in an output destination information DB;

FIG. 10 is a flowchart of an output process;

FIG. 11 illustrates an example of designation of output information using a mobile information terminal;

FIG. 12 is a flowchart of another example of S5;

FIG. 13 is a diagram for illustrating a concept of searching a similar image;

FIG. 14 illustrates an example of an arrangement of pieces of output information associated with each other based on an extraction keyword; and

FIG. 15 is a flowchart of another example of a template selection process (S4).

### DETAILED DESCRIPTION OF THE PREFERRED EMBODIMENTS

### First Embodiment

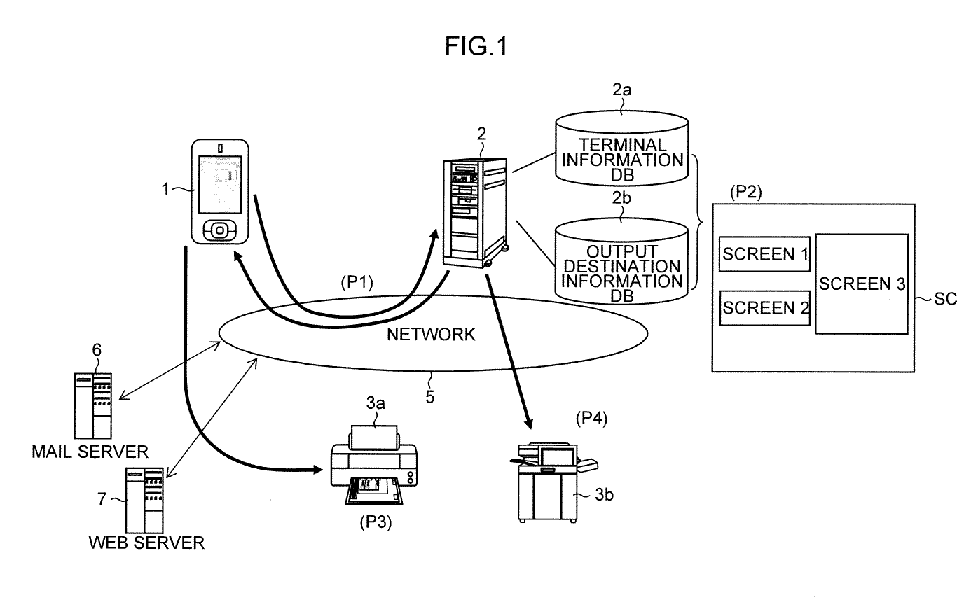

FIG. 1 illustrates a schematic configuration of a print system. This system includes a mobile information terminal 1, a server 2, and printers 3a and 3b (hereinafter, any one or both of the printers 3a and 3b may sometimes be referred to as a printer 3). The print system may be connected with a mail server 6 and a web server 7 via a network 5.

The mobile information terminal 1 may be a cellular phone, a PDA (personal digital assistance), or the like. The server 2 may be a personal computer. The server 2 includes a terminal information database (DB) 2a and an output destination information DB 2b.

The mobile information terminal 1 is connected with the server 2 and the printer 3 via the network 5. A communication system of the network 5 is not restrictive, and a LAN (local area network), the Internet, and the like may be used.

The printer 3a is connected with the mobile information terminal 1 via a communication path other than the network 5. The communication path between them is not restrictive, and a wireless system such as infrared rays and Bluetooth as well as a wired system such as a USB (universal serial bus) may be used. The printer 3a may or may not be connected with the server 2 via the network 5. The printer 3b is connected with the server 2 via the network 5.

Although the single mobile information terminal 1, the single printer 3a, and the single printer 3b are illustrated in the figure, each of them may be two or more.

In this system, when the mobile information terminal 1 transmits desired output information, which can be displayed on a screen of the terminal 1, to the server 2 (P1), the server 2 receives the output information and generates a print preview screen SC in which pieces of the output information are arranged in accordance with a template stored in advance in the terminal information DB 2a and suitable to (a model of) the mobile information terminal 1 (P2), and the server 2 transmits the output information corresponding to the print preview screen to the printer 3a through the mobile information terminal 1 using communication function such as Infrared communication and bluetooth (P3) or transmits directly the output information corresponding to the print preview screen to the printer 3b on a network (P4).

A template is information defining a layout of one or more pieces of desired output information (an image and/or a text) that is designated by a mobile information terminal 1 to which identification information is assigned depending on display capability suitable to the identification information of the mobile information terminal 1. A template defines an arrangement region corresponding to the number of the pieces of the designated output information. A template ID that is identification information of a template is assigned to the template.

By way of example, if a display unit 13 of a mobile information terminal 1 to which a terminal ID “T001” is assigned has display capability of QVGA (Quarter Video Graphics Array, screen resolution of 320×240 pixels, and display colors of 16), a template to which a template ID “tmp001” corresponding to the terminal ID “T001” is assigned defines an arrangement that n pieces of the designated information (note that pixel sizes of any piece of information are reduced to those of QQVGA (Quarter Quarter Video Graphics Array, screen resolution of 160×120 pixels) or less) are arranged in two columns in the vertical direction and in a predetermined order (for example, scanning in the horizontal direction).

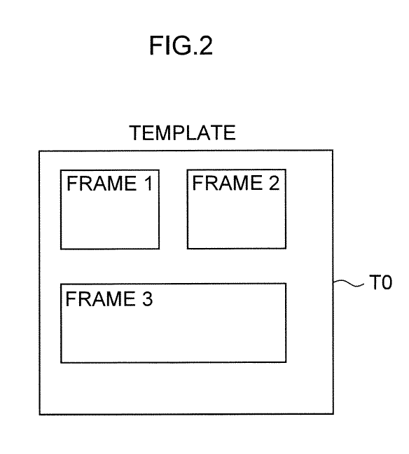

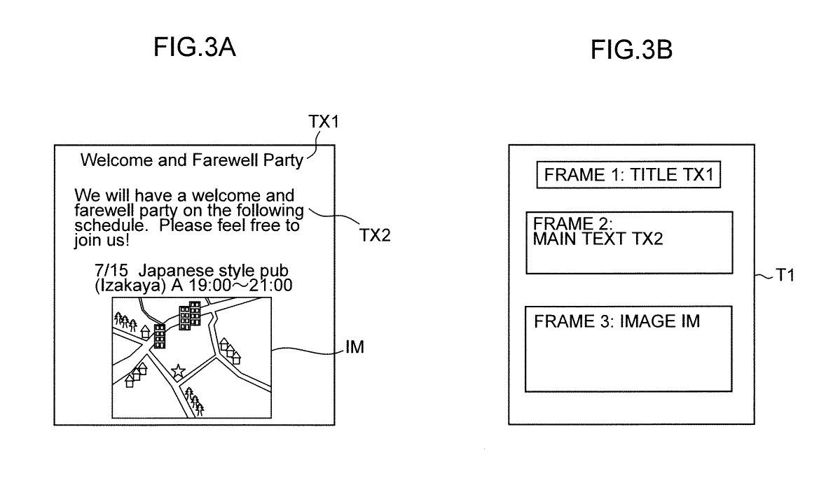

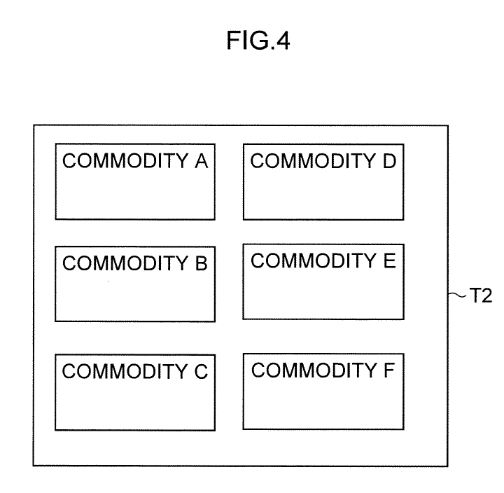

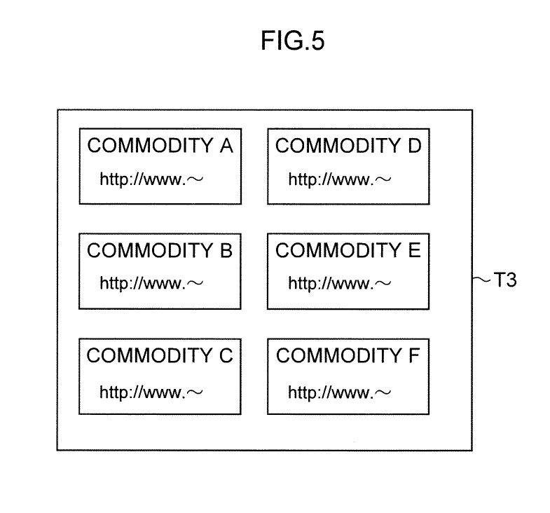

FIG. 2 illustrates a template example TO defining an arrangement of three pieces of information extracted from an image. FIG. 3A illustrates an example of a mail including three pieces of output information of a title text TX1, a main text TX2, and an image IM received from the mail server 6; and FIG. 3B illustrates a template example T1 including frames 1 to 3 defining an arrangement corresponding to the three pieces of output information of the mail. FIG. 4 illustrates a template example T2 defining an arrangement of six commodity images A to F selected as purchase candidates from an on-line shopping site of the web server 7 through an operation unit 14. FIG. 5 illustrates a template example T3 defining an arrangement of the six commodity images A to F selected as purchase candidates and information associated therewith (a URL (Uniform Resource Locator) or a Flash movie from which a related html (HyperText Markup Language) file is obtained).

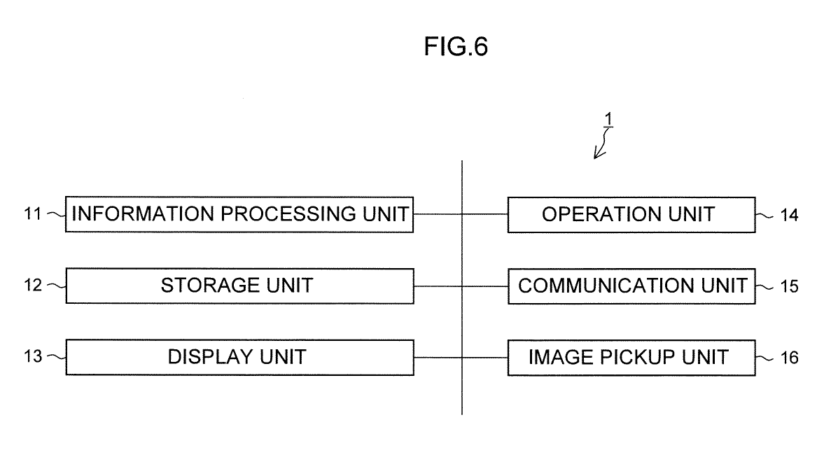

FIG. 6 illustrates a block configuration of the mobile information terminal 1. The mobile information terminal 1 includes an information processing unit 11, a storage unit 12, a display unit 13, the operation unit 14, and a communication unit 15. The storage unit 12, the display unit 13, and the operation unit 14 may be incorporated into the mobile information terminal 1 or may be an external peripheral device connected to the mobile information terminal 1.

The information processing unit 11 is composed of an information processing device such as a CPU (central processing unit) and a one-chip microcomputer. The storage unit 12 is a storage medium to/from which the information processing unit 11 can write/read information. Specifically, the storage unit 12 includes a volatile storage medium (RAM (random access memory)) and a non-volatile storage medium (such as ROM (read-only memory) and EEPROM (electrically erasable programmable read-only memory)). The storage unit 12 may include a mass storage medium such as an HDD (hard disc drive) and a device that writes/reads information to/from a portable information storage medium such as a CD-ROM (compact disc read only memory), a DVD (Digital Versatile Disc), an MO disc (magnetooptic disc), a memory card, a magnetic tape, and a punched tape.

The storage unit 12 stores a terminal ID that is information for identifying the mobile information terminal 1. A terminal ID is unique to a type of mobile information terminal 1.

The storage unit 12 also stores an image and/or a text being a source of output information described below. A source of output information may be obtained from anywhere. For example, an image or a text included in a mail received from the mail server 6 accessed by the mobile information terminal 1 via the network 5, an image or a text included in web contents received from the web server 7 accessed by the mobile information terminal 1 via the network 5, an image picked up by the mobile information terminal 1 through an image pickup unit 16, character information input by using the operation unit 14, and character information obtained through an OCR (optical character recognition) reader from an image picked up by using the image pickup unit 16 may be stored in the storage unit 12 as a source of output information.

For example, if a maintenance person for different types of devices carries a mobile information terminal 1, takes a picture of a broken device in close-up with the image pickup unit 16, inputs an outline of failure of the device with the operation unit 14, and a template for arranging the picture and the outline of failure in a report form has been prepared, a report of maintenance can be displayed as a preview on the mobile information terminal 1, and can also be output to the printer 3. Alternatively, if the mobile information terminal 1 receives a mail such as illustrated in FIG. 3A from the mail server 6, the mail contents can easily be displayed as a preview on the mobile information terminal 1 according to a template such as illustrated in FIG. 3B, and can also be output to the printer 3. Alternatively, if the mobile information terminal 1 receives a web page from the web server 7, the web page can easily be displayed as a preview on the mobile information terminal 1 according to a template such as illustrated in FIG. 5, and can also be output to the printer 3.

The display unit 13 is a device that displays desired information according to the control of the information processing unit 11, and includes an LCD (liquid crystal display) and a driver thereof, for example. The information to be displayed includes character information and image information stored in the storage unit 12 or obtained from the mail server 6 or the web server 7 via the network 5.

The operation unit 14 is a circuit that receives instructions from a user to the information processing unit 11, such as numerical keys, character keys, a scroll key, a determination key, a touch panel, an audio interface, and an eye-gaze interface. The information processing unit 11 controls the operations of each unit, such as the image pickup operation by the image pickup unit 16, the communicating operation by the communication unit 15, the displaying operation by the display unit 13, and the data storing operation by the storage unit 12, according to instructions from the operation unit 14.

The communication unit 15 is a communication interface that allows connecting to the server 2 and the printer 3a via the network 5. The communication unit 15 transmits/receives data using a communication protocol depending on a connection path. Data contents transmitted/received by the communication unit 15 are controlled by the information processing unit 11. The communication unit 15 can download image data and character data from the web server 7 or the mail server 6 connected therewith via the network 5 according to the control of the information processing unit 11, and store the downloaded data in the storage unit 12. Alternatively, the communication unit 15 can also transmit, to the server 2 and the printer 3, output information that is any data designated by the operation unit 14 from image data and character data obtained from the outside or stored in the storage unit 12, according to the control of the information processing unit 11.

The image pickup unit 16 is a circuit that converts an object image formed through an image pickup optical system into image data and outputs the converted image data, and includes a configuration of a known digital image data output device (a digital camera), such as the image pickup optical system (a focus lens, a zoom lens, and an aperture), an image pickup element (a CCD (charge-coupled device) or a CMOS (complementary metal-oxide semiconductor)), an analog front end circuit, an A/D (analog-to-digital) converter circuit, and an image processing circuit. The digital image data outputting operation of the image pickup unit 16 is controlled by the information processing unit 11. The information processing unit 11 stores temporarily image data output by the image pickup unit 16 in the RAM of the storage unit 12 and displays the image data in the RAM on the display unit 13. The information processing unit 11 also stores the image data in the RAM in the non-volatile storage medium such as the memory card in the storage unit 12 in response to instructions from the operation unit 14.

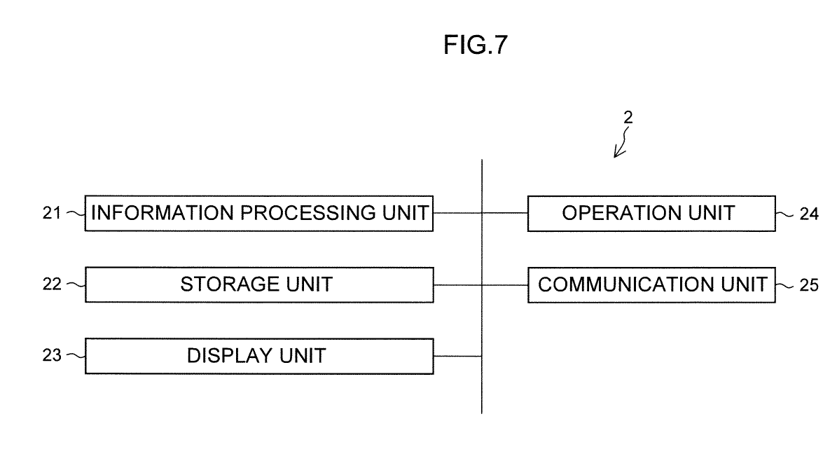

FIG. 7 illustrates a block diagram of the server 2. The server 2 includes an information processing unit 21, a storage unit 22, a display unit 23, an operation unit 24, and a communication unit 25. The information processing unit 21, the storage unit 22, the display unit 23, the operation unit 24, and the communication unit 25 may be configured in the same manner as the information processing unit 11, the storage unit 12, the display unit 13, the operation unit 14, and the communication unit 15, respectively.

The mass storage medium such as the HDD included in the storage unit 12 includes the terminal information DB 2a and the output destination information DB 2b.

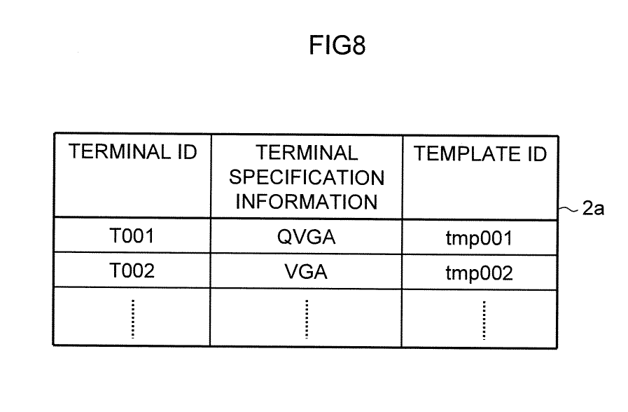

FIG. 8 illustrates an example of the configuration of the terminal information DB 2a. The terminal information DB 2a stores one or more sets of data, each set of which is composed of a terminal ID, terminal specification information, and a template ID.

The terminal specification information can include information representing display capability of the display unit 13 for displaying an image and/or a character, for example, the resolution of the screen (QVGA, VGA, etc.), maximum display colors, and a definition of a type of character that can be displayed.

The terminal information DB 2a preferably includes every terminal ID of unspecified mobile information terminals 1 that can be connected with the server 2 and all terminal specification information of the mobile information terminals 1.

A template ID is identification information of a template representing an arrangement of output data transmitted from the mobile information terminal 1 to the server 2. A template prepared for terminal information of the mobile information terminal 1, that is, for each combination of a terminal ID and terminal specification information of the mobile information terminal 1 is stored in the storage unit 22.

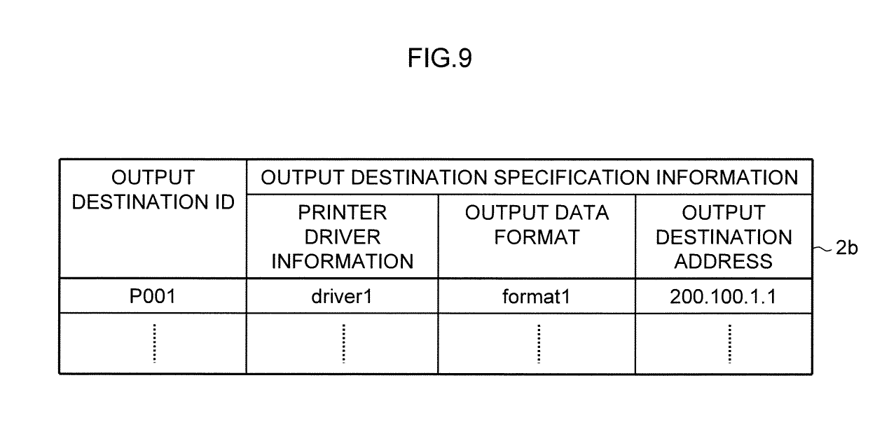

FIG. 9 illustrates an example of the configuration of the output destination information DB 2b. The output destination information DB 2b stores one or more sets of output destination information that is a data set composed of an output destination ID and output destination specification information. The output destination specification information is information representing outputting capability of the printer 3 for outputting an image and/or a character. By way of example, the output destination specification information is composed of a set of printer driver information, an output data format, and an output destination address. Alternatively, the output destination specification information can include a maximum print size, resolution, maximum print colors, and a definition of a type of character that can be printed.

The output destination ID is information for identifying the printer 3. The printer driver information, the output data format, and the output destination address each represent a printer driver, an output data format, and an address for the network 5, respectively, which are adopted in the printer 3 identified by the output destination ID associated with this set.

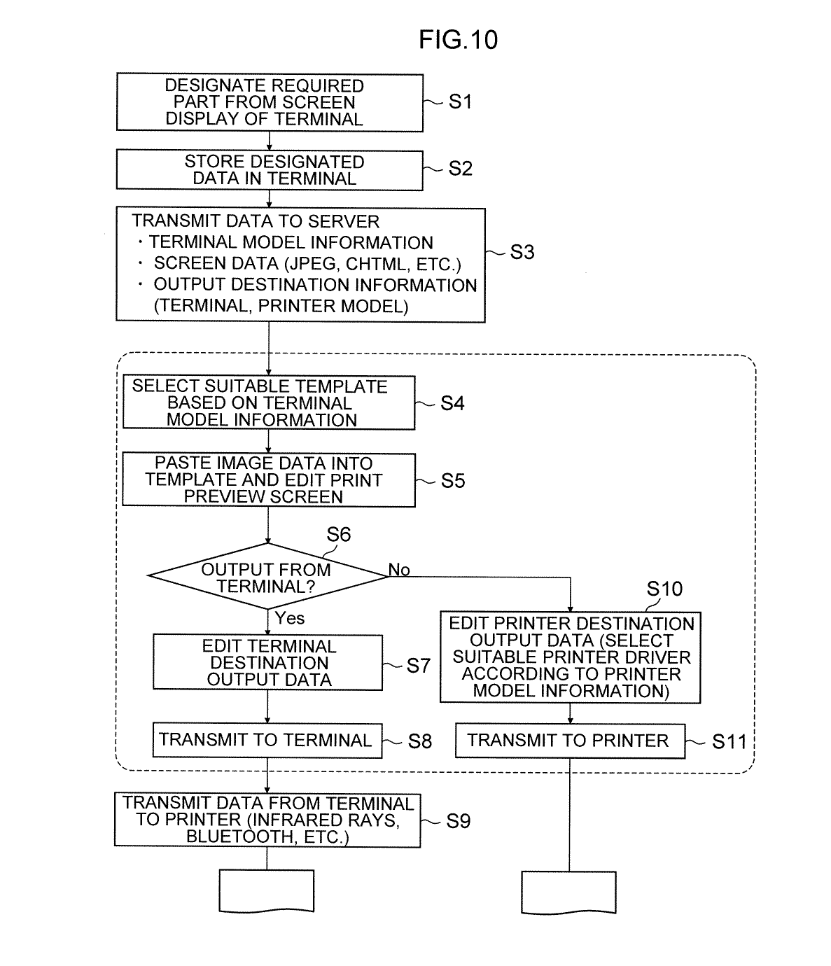

FIG. 10 illustrates a flowchart of an output process executed in the present system. A program for allowing the mobile information terminal 1 to execute S1 to S3 and S9 of this process, and a program for allowing the server 2 to execute S4 to S8 and S10 to S11 are stored in the storage unit 12 and the storage unit 22, respectively.

In S1, the information processing unit 11 of the mobile information terminal 1 receives the designation of output information through the operation unit 14. First, the information processing unit 11 allows, using the operation unit 14, desired data (an image and/or a text) to be input or selected from data stored in the storage unit 12. A text to be output information may be input through the operation unit 14. The information processing unit 11 allows the selected or input data to be displayed on the display unit 13. The information processing unit 11 further receives the designation of a part to be output information from the selected data.

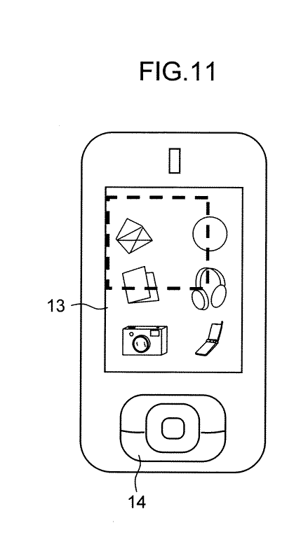

As illustrated in FIG. 11, for example, the mobile information terminal 1 displays the image data in the storage unit 12 selected according to the selection operation of the operation unit 14, on the display unit 13, and further receives the scope designation of a partial region of the image to be output information from the image data displayed on the display unit 13, through the operation unit 14. For example, the information processing unit 11 sets a frame on the image according to the operation with arrow keys or the touch panel of the operation unit 14, and recognizes a partial region surrounded with the frame as output information according to the operation of the determination key of the operation unit 14. A plurality of pieces of output information may be designated at a time or one by one. Of course, the entire image may be designated as output information. Output information of character information may also be designated according to the scope determination operation through the operation unit 14.

In S2, the information processing unit 11 of the mobile information terminal 1 stores temporarily the designated output information in the storage unit 12.

In S3, the information processing unit 11 of the mobile information terminal 1 controls the communication unit 15 to transmit the terminal ID and the output information that are stored in the storage unit 12 to the server 2.

In S4, the information processing unit 21 of the server 2 receives the terminal ID and the output information transmitted from the mobile information terminal 1 through the communication unit 25, and stores the received information in the storage unit 22. The information processing unit 21 refers to the terminal information DB 2a, and obtains terminal specification information (such as screen resolution) and a template ID corresponding to the received terminal ID from the terminal information DB 2a.

In S5, the information processing unit 21 of the server 2 selects and reads, from templates corresponding to the obtained template ID, a template defining an arrangement according to the number of the pieces of the received output information, from the non-volatile storage medium (such as the HDD) of the storage unit 22, and stores temporarily the read template in the volatile storage medium (the RAM) of the storage unit 22.

The information processing unit 21 creates an output image that is image data in which the received output information is laid out according to the selected template. The information processing unit 21 also converts the output image to an output image that is suitable to the obtained terminal specification information (such as screen resolution), and then creates a print preview screen. For example, the information processing unit 21 of the server 2 reduces the number of pixels so that an output size of the output image becomes suitable to the screen resolution included in the terminal specification information. Alternatively, if restriction such as display colors of the mobile information terminal 1 is described in the terminal specification information, the information processing unit 21 of the server 2 may reduce the colors of the output information to be suitable to the display colors of the terminal specification information.

In S6, the information processing unit 21 of the server 2 receives the determination to output the output information to the printer 3a via the mobile information terminal 1 or the determination to output the output information to the printer 3b via the server 2 through the operation unit 14 of the mobile information terminal 1. If the information processing unit 21 receives the determination that the output destination of the output information is the printer 3a, then the process proceeds to S7, and if the information processing unit 21 receives the determination that the output destination of the output information is the printer 3b, then the process proceeds to S10.

In S7, the information processing unit 21 of the server 2 requires the mobile information terminal 1 to transmit an output destination ID of the printer 3a. In response to the requirement from the server 2, the mobile information terminal 1 obtains the output destination ID of the printer 3a by communicating with the printer 3a, and transfers the output destination ID to the server 2 through the communication unit 15. The information processing unit 21 obtains, from the output destination information DB 2b, output destination specification information corresponding to the output destination ID of the printer 3a received from the mobile information terminal 1 through the communication unit 25. The information processing unit 21 creates corrected output information in which the output data is reconfigured to be suitable to the obtained output destination specification information. Note that the server 2 may require directly the printer 3a to transmit the output destination ID via the network 5, and in response to the requirement, the printer 3a may transmit directly the output destination ID of the printer 3a to the server 2 via the network 5.

In S8, the information processing unit 21 of the server 2 associates the corrected output information with the print preview screen and transmits them to the mobile information terminal 1 through the communication unit 25.

In S9, the information processing unit 11 of the mobile information terminal 1 receives the corrected output information and the print preview screen from the server 2 through the communication unit 15, and stores the received information and screen in the storage unit 12. The information processing unit 11 of the mobile information terminal 1 displays the stored print preview screen on the display unit 13. The information processing unit 11 of the mobile information terminal 1 then receives from the operation unit 14 the determination whether or not to output to the printer 3a the corrected output information corresponding to the displayed print preview screen. In response to the reception of the determination of outputting the corrected output information to the printer 3a, the information processing unit 11 transmits the corrected output information to the printer 3a through the communication unit 15. The printer 3a prints out an image and/or a character based on the corrected output information received from the mobile information terminal 1.

In S10, the information processing unit 21 of the server 2 requires, through the communication unit 25, the printer 3b to transmit an output destination ID of the printer 3b. The printer 3b transfers the output destination ID of the printer 3b to the server 2 via the network 5. The information processing unit 21 obtains, from the output destination information DB 2b, output destination specification information corresponding to the output destination ID received from the printer 3b through the communication unit 25. The information processing unit 21 creates corrected output information in which the output image is reconfigured so that the output data is suitable to the obtained output destination specification information. The corrected output information may be created from the preview image. The information processing unit 21 of the server 2 controls the communication unit 25 to transmit the corrected output information to the printer 3b. The printer 3b prints out an image and/or a character based on the corrected output information received from the server 2.

According to the process described above, a user can select desired output information using the mobile information terminal 1, and check a layout of the output information selected by the user by referring to a print preview screen displayed on the display unit 13 of the mobile information terminal 1. The user can also select any printout destination of the output information using the mobile information terminal 1.

### Second Embodiment

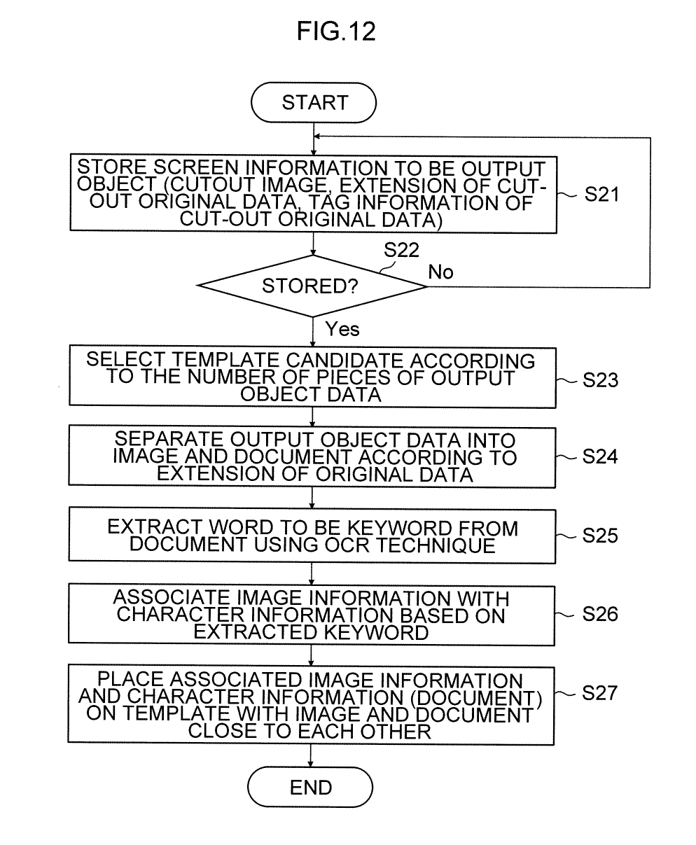

FIG. 12 illustrates a flowchart of another example of the process for creating a print preview screen (S5).

In S21, the information processing unit 21 of the server 2 stores in the storage unit 22 the output information and additional information of an original image of which a partial region that is the output information is cut out. These pieces of information include the partial region of the image and the text that are output objects designated in 51, an extension of the original image of which the partial region is cut out, and tag information of this image. Note that the information processing unit 21 may regard, as the additional information of the image, character information recognized from the partial region of the image designated as the output information by using OCR.

In S22, the information processing unit 21 determines whether all the output information and the additional information have been stored, depending on whether determination instructions of the partial region have been input through the operation unit 14 of the mobile information terminal 1. If yes, the process proceeds to S23, and if no, the process goes back to S22 and the information processing unit 21 receives designation of the partial region.

In S23, the information processing unit 21 selects a template candidate from templates corresponding to the terminal ID depending on the number of the pieces of the output information.

In S24, the information processing unit 21 separates the output information into image information and character information.

In S25, the information processing unit 21 extracts keywords from each of the separated character information and the additional information of the image information. The keywords are defined in advance in the storage unit 22. The information processing unit 21 may receive a definition of a desired keyword through the operation unit 14 of the mobile information terminal 1 and store the keyword in the storage unit 22.

In S26, the information processing unit 21 associates the character information with the image information both included in the output information, based on the identity of the keyword extracted from the character information and the keyword extracted from the additional information of the image information. For example, it is assumed that the keywords “sakura, hana-mi (cherry blossom, cherry-blossom viewing in English)” are extracted from character information designated as output information (an output object 1), and the keywords “sakura, hana (cherry blossom, flower in English)” are extracted from additional information of a partial region of an image designated as output information (an output object 2). In this instance, since the output object 1 and the output object 2 both have the same keyword “sakura,” the information processing unit 21 associates the output object 1 with the output object 2. In the same manner, three or more partial regions may be associated with each other.

If no keywords are included or sufficient keywords are not included in the additional information corresponding to the partial region, the information processing unit 21 may analyze and extract an image feature amount of the partial region, and check the image feature amount against image feature amounts of images stored in an image server (not illustrated), thereby searching a similar image from the image server and regarding tag information corresponding to the similar image as additional information corresponding to the partial region.

An image feature amount may include a feature amount regarding a pixel value of image data such as a mean, a variance, a maximum, a minimum, and a luminance histogram; a feature amount regarding a position of an extracted region, and a shape of the extracted region such as a degree of circularity of a profile and a moment; a feature amount regarding a size such as a radius of a cross section, a volume, and a surface area; and shape information and texture information of an ROI (region of interest). Alternatively, a value obtained by manipulating these pieces of information by using a predetermined formula (e.g., a main constituent analysis and an independent constituent analysis) may be used as a feature amount. In summary, a profile, a pixel value, position information, and the like of a region of interest obtained by a known technique may be used as an image feature amount.

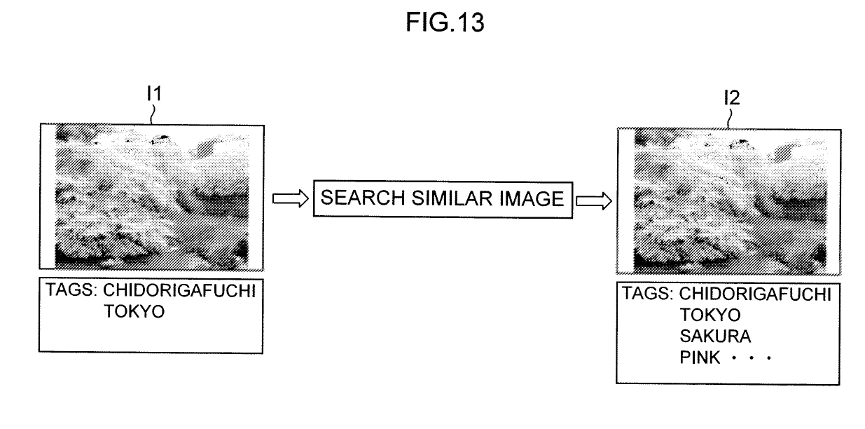

As illustrated in FIG. 13, for example, the information processing unit 11 searches from the image server a similar image 12 having an image feature amount similar to an image feature amount of a partial region I1, and recognize “sakura and pink,” which are not included in tag information of the partial region I1, from the tag information “Chidorigafuchi, Tokyo, sakura, and pink” associated with the similar image 12, as new tag information of the partial region I1. The information processing unit 11 may store the new tag information in the storage unit 12 as the tag information of the partial region Il. Whether the information processing unit 11 searches a similar image or not may depend on instructions of the operation unit 14. The information processing unit 11 then associates the character information with the image based on the identity of the extracted keywords.

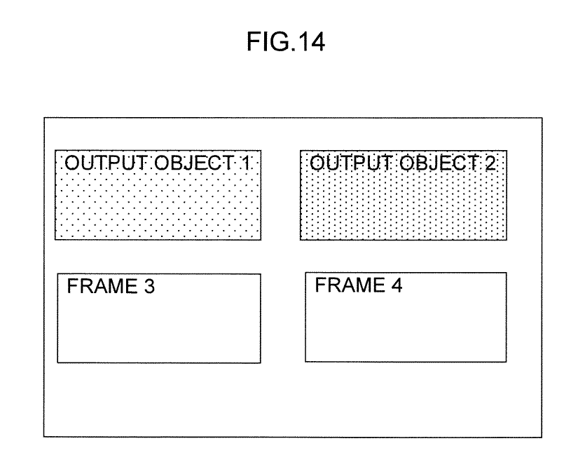

In S27, the information processing unit 21 determines output positions of the associated character information and image on the selected template candidate. The output positions of the associated partial regions, for example, the above-described output object 1 and output object 2 are preferably close to each other (see FIG. 14). The information processing unit 21 generates a print preview screen that is an image in which the pieces of the output information are arranged according to the determined output positions. The information processing unit 21 also creates corrected output information in which the arrangement is maintained, and outputs the corrected output information to the printer 3a or 3b in response to instructions from the mobile information terminal 1. Thus, by checking keywords of character information against keywords of additional information of an image, an image and characters highly relevant in content can be arranged in association with a preview image or printout data.

### Third Embodiment

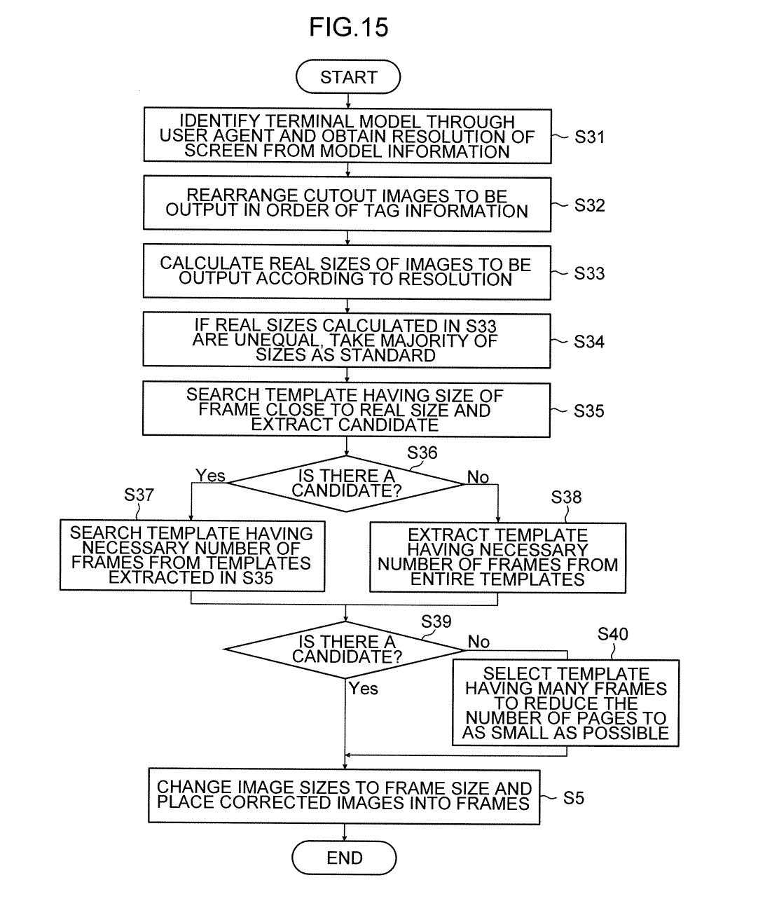

FIG. 15 illustrates a flowchart of another example of a template selection process (S4).

In S31, the mobile information terminal 1 gives the server 2 information representing the screen resolution of the display unit 13 of the mobile information terminal 1 through a user agent or the like, and the information processing unit 21 of the server 2 stores in the storage unit 22 the information transmitted from the mobile information terminal 1. Alternatively, the information processing unit 21 of the server 2 may receive through the communication unit 25 the terminal ID and the output information (i.e., the partial region of the image) transmitted from the mobile information terminal 1, refer to the terminal information DB 2a, and obtain screen resolution corresponding to the received terminal ID from the terminal information DB 2a. The information processing unit 21 of the server 2 also receives through the communication unit 25 and stores in the storage unit 22 the output information transmitted from the mobile information terminal 1 and the additional information of the original image of which the partial region being the output information has been cut out.

In S32, the information processing unit 21 of the server 2 rearranges the pieces of the output information based on the additional information, received in S31, of the original image of which the output information has been cut out. For example, the information processing unit 21 sorts each piece of the output information corresponding to each piece of additional information in the order of the Japanese syllabary or in an alphabetical order of keywords included in the additional information, or in ascending or descending order of image registration dates included in the additional information.

In S33, the information processing unit 21 of the server 2 calculates real display sizes of each piece of the output information based on the received screen resolution. A real display size is a maximum size of output information that can be displayed on the display unit 13 with an aspect ratio of the output information maintained.

In S34, if the real display sizes of each piece of the output information are identical to each other, the information processing unit 21 of the server 2 recognizes the real display size as screen resolution (terminal specification information) that is a standard for extracting a template. If the real display sizes of each piece of the output information are not identical to each other, the information processing unit 21 of the server 2 recognizes a majority of the real display sizes as screen resolution (terminal specification information) that is a standard for extracting a template. Alternatively, if the real display sizes of each piece of the output information are not identical to each other, the information processing unit 21 of the server 2 may recognize a value obtained by substituting the real display sizes of each piece of the output information such as a maximum value, a minimum value, and a mean value of the real display sizes into a predetermined arithmetic formula, as screen resolution (terminal specification information) that is a standard for extracting a template.

In S35, the information processing unit 21 of the server 2 extracts from the terminal information DB 2a a template ID corresponding to the screen resolution (terminal specification information) recognized in S34. If a template ID corresponding to the screen resolution recognized in S34 is not present in the terminal information DB 2a, the information processing unit 21 extracts a template ID corresponding to screen resolution that is most approximate to the screen resolution from the terminal information DB 2a.

In S36, the information processing unit 21 of the server 2 determines whether or not at least one template ID has been extracted in S35. If yes, the process proceeds to S37, and if no, the process proceeds to S38.

In S37, the information processing unit 21 of the server 2 searches and extracts from the terminal information DB 2a a template that defines an arrangement region corresponding to the number of pieces of the designated output information from templates corresponding to the template ID extracted in S35.

In S38, the information processing unit 21 of the server 2 searches and extracts from the terminal information DB 2a a template that defines an arrangement region corresponding to the number of pieces of the designated output information.

In S39, the information processing unit 21 of the server 2 determines whether or not at least one template has been extracted in S37 or S38. If yes, the process proceeds to S5, and if no, the process proceeds to S40.

In S40, the information processing unit 21 of the server 2 searches and extracts from the terminal information DB 2a a template that defines a maximum number of arrangement regions. The process then proceeds to S5. An aim of S40 is to reduce the number of pages of a print preview screen created in S5.

S5 is as described above. Note that here, the information processing unit 21 creates an output image that is image data in which the received output information is laid out according to a template extracted in S37, S38, or S40.

A layout order of the pieces of the output information on the arrangement regions follows the order defined in S32. For example, if an arrangement order is given to each arrangement region, the output information is laid out so that the arrangement order matches with the order defined in S32. By way of specific example, the “output information 1” corresponding to the keyword “Chidorigafuchi” is placed on the arrangement region of the “arrangement order 1,” and the “output information 2” corresponding to the keyword “Tokyo” is placed on the arrangement region of the “arrangement order 2.”

The information processing unit 21 also converts the output image to an output image suitable to the obtained terminal specification information (such as screen resolution), and creates a print preview screen.

The presently disclosed subject matter can be provided as a computer-readable program code for causing a device to execute the above described process, a non-transitory computer-readable recording medium (for example, an optical disc such as a CD (Compact Disc), a DVD (Digital Versatile Disc) and a BD (Blu-ray Disc), a magnetic disc such as a hard disc, a magneto-optical disc) on which the computer-readable program code is stored or a computer program product including the computer-readable program code.

What is claimed is:

1. An image output device comprising:
a communication unit capable of communicating information with a mobile information terminal connected with the communication unit;
a layout definition information storage unit configured to store layout definition information defining a layout of output information suitable to a display capability for each mobile information terminal to which identification information is assigned;
an output information designation unit configured to receive designation of desired output information through the mobile information terminal connected with the communication unit;
a reception unit configured to receive the identification information of the mobile information terminal from the mobile information terminal connected with the communication unit;
a selection unit configured to select, from the layout definition information storage unit, layout definition information corresponding to the identification information of the mobile information terminal received by the reception unit; and
an image processing unit configured to create an image in which the output information of which the output information designation unit has received the designation is arranged according to a layout defined by the layout definition information selected by the selection unit.

2. The image output device according to claim 1, wherein
the display capability of the mobile information terminal includes at least one of screen resolution and display colors of the mobile information terminal; and
the image processing unit creates an image in which the output information is arranged to be suitable to the at least one of the screen resolution and the display colors of the mobile information terminal.

3. The image output device according to claim 2, wherein
the selection unit calculates output sizes of each piece of the output information of which the output information designation unit has received the designation, based on the screen resolution of the mobile information terminal connected with the communication unit, and selects the layout definition information according to identity of the calculated output sizes of each piece of the output information.

4. The image output device according to claim 3, wherein
if the calculated output sizes of each piece of the output information are not identical to each other, the selection unit selects, from the layout definition information storage unit, layout definition information corresponding to a majority of the output sizes in the calculated output sizes of each piece of the output information.

5. The image output device according to claim 4, wherein
the selection unit selects, from the layout definition information storage unit, layout definition information suitable to screen resolution most approximate to the majority of the output sizes.

6. The image output device according to claim 1, further comprising:
a printer output definition information storage unit configured to store printer output definition information defining an output specification for each printer;
a printer designation unit configured to receive designation of a desired printer through the mobile information terminal;
a print data processing unit configured to create print data suitable to the output specification defined by printer output definition information corresponding to the printer of which the printer designation unit has received the designation, in the printer output definition information storage unit, based on the output information arranged according to the layout defined by the layout definition information selected by the selection unit; and
a transmitting unit configured to transmit the print data from the print data processing unit to the printer of which the printer designation unit has received the designation.

7. The image output device according to claim 1, further comprising
an image transmitting unit configured to transmit an image from the image processing unit to the mobile information terminal connected with the communication unit.

8. An image output system comprising:
an image output device according to claim 1; and
a mobile information terminal.

9. An image output method, wherein an information processing device executes the steps of:
storing in a storage medium layout definition information defining a layout of output information suitable to a display capability for each mobile information terminal to which identification information is assigned;
receiving designation of desired output information through the mobile information terminal;
receiving the identification information of the mobile information terminal from the mobile information terminal;
selecting from the storage medium layout definition information corresponding to the received identification information of the mobile information terminal; and
creating an image in which the output information, the designation of which has been received, is arranged according to a layout defined by the selected layout definition information.

10. A computer-readable recording medium including instructions stored thereon, such that when the instructions are read and executed by a processor, the processor is configured to perform the steps of:
storing in a storage medium layout definition information defining a layout of output information suitable to a display capability for each mobile information terminal to which identification information is assigned;
receiving designation of desired output information through the mobile information terminal;
receiving the identification information of the mobile information terminal from the mobile information terminal;
selecting from the storage medium layout definition information corresponding to the received identification information of the mobile information terminal; and
creating an image in which the output information, the designation of which has been received, is arranged according to a layout defined by the selected layout definition information.
